(19) United States
(12) Patent Application Publication
(10) Pub. No.: US 2009/0161176 A1
(43) Pub. Date: Jun. 25, 2009

(54) SHEET MUSIC CREATION METHOD AND IMAGE PROCESSING APPARATUS

(75) Inventors: Manabu Yamazoe, Tokyo (JP); Fumihiro Goto, Kawasaki-shi (JP); Ayumi Hori, Kawasaki-shi (JP); Tohru Ikeda, Yokohama-shi (JP); Maya Ishii, Kawasaki-shi (JP); Hidetsugu Kagawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/339,986

(22) Filed: Dec. 19, 2008

(30) Foreign Application Priority Data
Dec. 21, 2007 (JP) 2007-331073

(51) Int. Cl. H04N 1/04; G09B 15/02

(52) U.S. Cl. 358/474; 84/483.1

(57) ABSTRACT

A sheet music creation method of creating sheet music whose layout is changed based on image data of sheet music input from an input device includes the steps of dividing the image data of the sheet music input from the input device into grand staffs, designating the grand staffs divided in the dividing in the order of performance, and re-editing, by a processor, image data representing the grand staffs in accordance with the order designated in the designating.

### BACKGROUND OF THE INVENTION

1. Field of the Invention

The present invention relates to a sheet music creation method and image processing apparatus for creating sheet music whose layout is changed based on image data of sheet music input from an input device.

2. Description of the Related Art

As low-cost scanner devices become available, an original can be easily scanned and converted into digital data even at home. Inkjet printers as printing apparatuses have been developed, and even a multifunctional peripheral called a multi-function printer (MFP) capable of not only printing an image, but also scanning an image becomes popular. The user can use a scanner device and printer device to easily copy his originals and contents at home.

An example of contents which improve a user's convenience when copied is “sheet music” of music. In general, the user purchases sheet music as a book. However, it impairs a user's convenience to set sheet music purchased as a book directly on a music stand. For example, when the user sets sheet music of many pages directly on a music stand to see a desired page, he must forcibly open the sheet music, damaging the sheet music. To prevent this, a music stand devised to fix sheet music at a desired page is also commercially available. However, such a music stand makes it difficult to turn a page. It is generally cumbersome to turn a page of sheet music during the performance. This work is very troublesome especially during the performance of a musical instrument using both hands, such as the piano.

During the music lesson of the piano or the like, the teacher often writes an instruction directly on sheet music. It is popular to copy sheet music and keep the original clean.

When editing and distributing sheet music of a composition by a user or when editing music composed in response to a user's request and distributing it as sheet music, various editing operations are required. For this purpose, a technique for, for example, editing sheet music is disclosed.

For example, Japanese Patent Laid-Open Nos. 06-149235 and 06-149236 disclose methods of shaping the inside of a column in accordance with the coordinates of the top staff to those of the bottom one, and aligning the left ends of recognized staffs in the horizontal direction.

### SUMMARY OF THE INVENTION

Sheet music is generally edited to decrease the number of pages using a repeat mark and the like. However, sheet music edited in this way is not always optimum for a performance.

For example, sheet music as a general book describes information for a performance on the basis of rules built up through the historical development. Sheet music is not convenient for all players. A player edits sheet music by, for example, copying it and dividing the copy into a plurality of pieces of paper so as to easily turn a page, or coloring sheet music or adding signs to it so as to easily play for himself. The editing work optimizes sheet music for the player. However, it is very cumbersome for the player to edit sheet music, so demands have arisen for easily editing sheet music.

To efficiently create sheet music, repetitive parts such as repeats are generally described as a single part using marks. For example, even if the player copies sheet music for a performance by himself, and binds the copies of sheet music in the form of accordion fold or the like so as to easily turn a page, the music sometimes returns to a previous part. The sheet music is not always actually convenient for the player. Especially when pages are complicatedly turned among many pages, like classical music, sheet music is not edited for user's convenience.

The present invention provides a sheet music creation method and image processing apparatus capable of easily creating sheet music whose layout is edited for user's convenience even when pages are complicatedly turned among many pages.

The present invention in its first aspect provides a sheet music creation method of creating sheet music whose layout is changed based on image data of sheet music input from an input device, the method comprises of: dividing the image data of the sheet music input from the input device into grand staffs; designating the grand staffs divided in the dividing step in order of performance; and re-editing, by a processor, image data representing the grand staffs in accordance with the order designated in the designating step.

The present invention in its second aspect provides an image processing apparatus which is connected to an input device and creates sheet music whose layout is changed based on image data of sheet music input from the input device, the apparatus comprises: a division unit configured to divide the image data of the sheet music input from the input device into grand staffs; a designation unit configured to designate the grand staffs divided by the division unit in order of performance; and a re-editing unit configured to re-edit, by a processor, image data representing the grand staffs in accordance with the order designated by the designation unit.

The present invention in its third aspect provides an image processing apparatus which includes an input device and creates sheet music whose layout is changed based on image data of sheet music input from the input device, the apparatus comprises: a division unit configured to divide the image data of the sheet music input from the input device into grand staffs; a designation unit configured to designate the grand staffs divided by the division unit in order of performance; and a re-editing unit configured to re-edit, by a processor, image data representing the grand staffs in accordance with the order designated by the designation unit.

The present invention can easily create sheet music whose layout is edited for user's convenience even when pages are complicatedly turned among many pages.

Further features of the present invention will become apparent from the following description of exemplary embodiments with reference to the attached drawings.

### BRIEF DESCRIPTION OF THE DRAWINGS

FIG. 1 is a conceptual view showing an example of the configuration of an image processing system according to the present invention;

FIG. 2 is a block diagram of the image processing system in FIG. 1;

FIG. 3 is a schematic perspective view of the outer appearance of an MFP according to an embodiment of the present invention;

FIG. 4 is a block diagram of the MFP shown in FIG. 3;

FIG. 5 is a flowchart of image processing executed in copying;

FIG. 6 is a flowchart showing an outline of the operation of an image processing method according to the present invention;

FIG. 7 is a schematic view of sheet music data input from an input device and re-edited sheet music data;

FIG. 8 is a view showing reference coordinates in actual sheet music;

FIG. 9 is a view for explaining details of re-editing of sheet music;

FIG. 10 is a schematic view of sheet music data input from an input device and re-edited sheet music data;

FIG. 11 is a schematic view of sheet music data input from an input device;

FIG. 12 is a schematic view of re-edited sheet music data; and

FIG. 13 is a schematic view of re-edited sheet music data.

### DESCRIPTION OF THE EMBODIMENTS

Embodiments of the present invention will be described in detail below with reference to the accompanying drawings. The same reference numerals denote the same parts, and a description thereof will not be repeated.

### <PC Application>

An embodiment for practicing the present invention by application software running on a personal computer (to be referred to as a PC hereinafter) serving as a host apparatus will be explained.

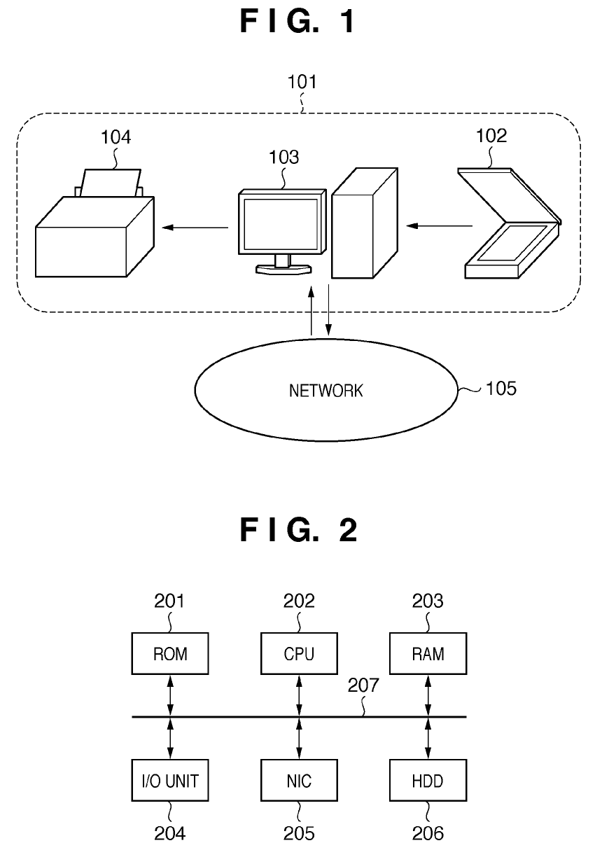

FIG. 1 is a conceptual view showing an example of the configuration of an image processing system including an image processing apparatus (a PC 103) according to the present invention.

An image processing system 101 in FIG. 1 includes a scanner 102 serving as an image reading apparatus, the PC 103, and a printer 104 serving as a printing apparatus. It is possible to change the layout of sheet music scanned by the scanner 102 and print the resultant sheet music by the printer 104. The PC 103 is connected to an external network 105.

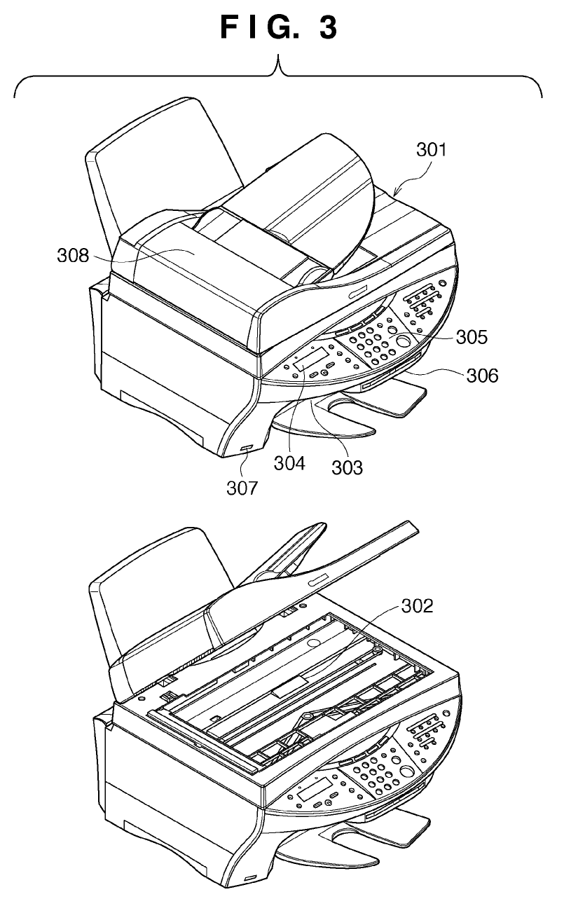

FIG. 2 is a block diagram of the PC 103 of the image processing system 101 shown in FIG. 1.

In FIG. 2, reference numeral 201 denotes a ROM (Read Only Memory); 202, a CPU (Central Processing Unit); and 203, a RAM (Random Access Memory). Reference numeral 204 denotes an I/O unit (Input/Output unit). Reference numeral 205 denotes a NIC (Network Interface Card). Reference numeral 206 denotes an HDD (Hard Disk Drive). Reference numeral 207 denotes a bus.

The CPU 202 controls the operation of the overall image processing apparatus (PC 103) via the bus 207 in accordance with a program and data stored in the ROM 201. For example, the CPU 202 controls re-editing of sheet music according to the present invention. At the same time, the CPU 202 performs image processing using the RAM 203 as a work memory. For example, the CPU 202 performs image processing for image data input via the I/O unit 204 or NIC 205, or image data stored in advance in a storage medium such as the HDD 206. The CPU 202 outputs the processed image data via the I/O unit 204 or NIC 205, or stores it in a storage medium such as the HDD 206.

For example, the I/O unit 204 is connected via a predetermined interface to an image input/output device such as a monitor (e.g., CRT or LCD), a printer, or a scanner, or a storage device having a storage medium such as a magnetic disk or optical disk. The I/O unit 204 can receive/output image data via the NIC 205 from/to a computer device connected to the storage device and the above-mentioned image input/output device. Examples of the network are Ethernet, FDDI (Fiber Distributed Data Interface), IEEE1394 serial bus, and USB (Universal Serial Bus).

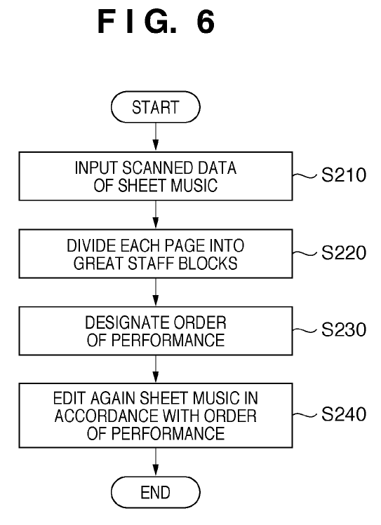

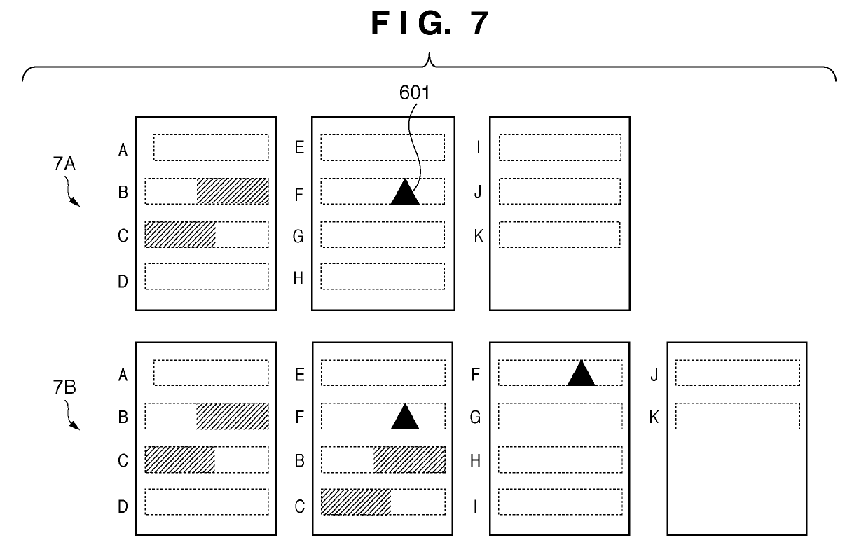

An outline of an image processing operation using the above-described arrangement will be explained with reference to the flowchart of FIG. 6. First, scanned data of sheet music is input (step S210), and each page is divided into grand staff blocks (step S220). Then, the order of performance of the respective blocks is designated in accordance with a user instruction (step S230), and the sheet music is edited again in accordance with the designated order (S240). In step S230, for example, information on signs of sheet music may also be stored in advance in a memory to automatically designate the order of performance in accordance with the information.

### <MFP>

The same effects as the above-described ones can also be obtained by using an image processing system in which a single image processing apparatus operates without the mediacy of a PC.

FIG. 3 is a schematic perspective view of the outer appearance of a multi-function printer (to be referred to as an MFP hereinafter) 301 serving as a multifunctional peripheral according to an embodiment of the present invention. The MFP 301 has the function of a general PC printer which receives data from a PC and prints it, and the function of a scanner. Further, the MFP 301 has, as a function executed by a single MFP, a copy function of printing, by a printer, an image scanned by a scanner, a function of directly reading image data stored in a memory card or the like and printing it, or a function of receiving image data from a digital camera and printing it.

In FIG. 3, the MFP 301 includes a reading unit 302 such as a flat-bed scanner, a printing unit 303 of an inkjet type, electrophotography, or the like, a display unit 304 serving as a display panel, and an operation unit 305 serving as an operation panel having various keys, switches, and the like. A USB port (not shown) is provided on the rear surface of the MFP 301 as a PC interface for communicating with a PC, and enables communication with a PC. In addition to these components, the MFP 301 includes a card interface 306 serving as a card slot for reading out data from a variety of memory cards, and a camera interface 307 serving as a camera port for communicating data with a digital camera. Further, the MFP 301 includes an auto document feeder (to be referred to as an ADF hereinafter) 308 for automatically setting an original onto the original table.

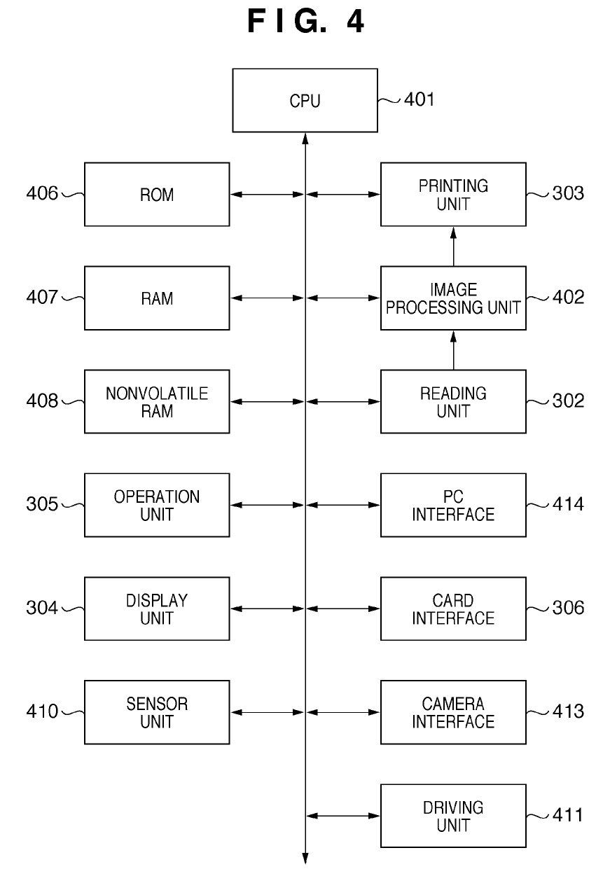

FIG. 4 is a block diagram of the image processing system 101 shown in FIG. 3.

In FIG. 4, a CPU 401 is a processor which controls various functions of the MFP, and executes an image processing program stored in a ROM 406 in accordance with a predetermined operation to the operation unit 305. For example, the CPU 401 controls re-editing of sheet music according to the present invention.

The reading unit 302 having a CCD reads an original image to output analog luminance data of red (R), green (G), and blue (B). The reading unit 302 may also include a contact image sensor (CIS) instead of the CCD. When the ADF 308 as shown in FIG. 3 is provided, the reading unit 302 can successively read the original images of order sheets set on the ADF 308.

The card interface 306 receives, in accordance with a predetermined operation to the operation unit 305, image data captured by a digital camera or the like and recorded on a memory card or the like. If necessary, an image processing unit 402 converts image data received via the card interface 306. For example, the image processing unit 402 converts image data corresponding to the color space (e.g., YCbCr) of a digital camera into one corresponding to the RGB color space (e.g., NTSC-RGB or sRGB). If necessary, the received image data undergoes various processes necessary for an application, such as resolution conversion into an effective pixel count on the basis of header information of the image data.

A camera interface 413 is directly connected to a digital camera to read image data.

The image processing unit 402 performs image processes (to be described later) such as image analysis, calculation of the conversion characteristic, conversion from a luminance signal (RGB) into a density signal (CMYK), scaling, gamma conversion, and error diffusion. Data obtained by these image processes are stored in a RAM 407. When corrected data stored in the RAM 407 reach a predetermined amount necessary to print by the printing unit 303, the printing unit 303 executes a print operation.

A nonvolatile RAM 408 is, for example, a battery backup SRAM, and stores data unique to the MFP and the like.

The operation unit 305 has a photo direct print start key to select image data stored in a storage medium and start printing, a key to print an order sheet, and a key to read an order sheet. The operation unit 305 also has a copy start key to perform monochrome copying or color copying, a mode key to designate a mode such as resolution or image quality in copying, a stop key to stop a copy operation or the like, a ten-key pad to input the number of copies, a registration key, and the like. The CPU 401 detects the pressed states of these keys, and controls each unit in accordance with the states.

The display unit 304 includes a dot matrix type liquid crystal display (LCD) and LCD driver, and presents various displays under the control of the CPU 401. The display unit 304 displays the thumbnail of image data stored in a storage medium.

The printing unit 303 includes an inkjet head, general-purpose IC, and the like. The printing unit 303 reads out print data stored in the RAM 407, and prints it out as a hard copy under the control of the CPU 401.

A driving unit 411 includes a stepping motor for driving feed and delivery rollers in the operations of the reading unit 302 and printing unit 303, a gear for transmitting the driving force of the stepping motor, and a driver circuit for controlling the stepping motor.

A sensor unit 410 includes a sensor for detecting the width of a print medium, a sensor for detecting the presence/absence of a print medium, a sensor for detecting the width of an original image, a sensor for detecting the presence/absence of an original image, and a sensor for detecting the type of print medium. Based on pieces of information obtained from these sensors, the CPU 401 detects the states of an original and print medium.

A PC interface 414 is an interface between the PC and the MFP. The MFP executes operations such as printing and scanning on the basis of instructions transmitted from the PC via the PC interface 414.

In copying, image data of an original image read by the reading unit 302 is processed in the MFP, and printed by the printing unit 303. When the user designates a copy operation via the operation unit 305, the reading unit 302 reads an original set on the original table. Image data of the read original image is transmitted to the image processing unit 402, and undergoes image processing (to be described later). The processed image data is transmitted to the printing unit 303, and printed.

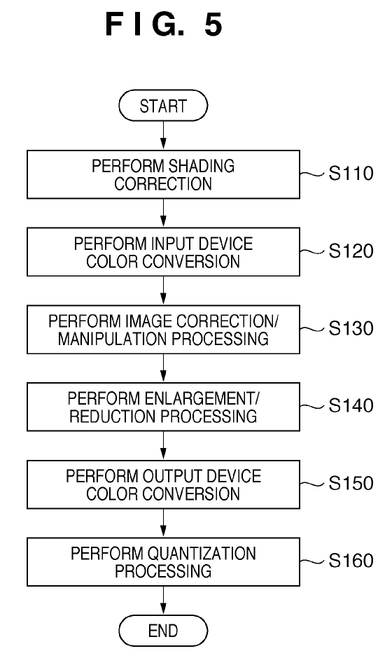

FIG. 5 is a flowchart of image processing executed in copying. Respective steps will be explained, but a detailed description of steps which are not essential to the present invention will be omitted.

In step S110, image data which is read by the reading unit 302 and A/D-converted undergoes shading correction to correct variations of image sensors.

In step S120, the image data undergoes input device color conversion to convert image data corresponding to a color space unique to the reading unit 302 serving as an input device into image data corresponding to a standard color space. More specifically, the image data is converted into image data corresponding to a color space such as sRGB defined by IEC (International Electrotechnical Commission) or AdobeRGB proposed by Adobe Systems. The conversion method is, for example, an arithmetic method based on a 3×3 or 3×9 matrix, or a look-up table method of looking up to a table describing a conversion rule and deciding a color space on the basis of the table.

In step S130, the image data having undergone color conversion undergoes image correction/manipulation processing. The processing contents include edge emphasis processing of correcting blurring generated upon reading an original image, processing of removing offset generated upon reading by light irradiation, and character manipulation processing for improving character readability.

In step S140, enlargement/reduction processing is executed to convert the image data at a desired ratio when the user designates resizing or in layout copying of laying out two original sheets on one paper sheet. The conversion method is generally a bicubic method, nearest neighbor method, or the like. When laying out and printing a plurality of images on one print medium in layout copying or the like, the operations in steps S110 to S140 are repeated to read a plurality of images and lay out the read images on one page. Then, the process shifts to the following print operation.

In step S150, the image data corresponding to the standard color space is converted into image data corresponding to a color space unique to an output device. Similar to step S120, the conversion method suffices to be the arithmetic method based on a matrix or the look-up table method. Image data corresponding to the color space unique to the output device is converted into one corresponding to the color space of the colors of inks used in an inkjet MFP, such as cyan, magenta, yellow, and black.

In step S160, the image data undergoes quantization processing. For example, when an ink dot is expressed by a binary value representing whether or not to discharge an ink dot, the image data suffices to be binarized according to a quantization method such as error diffusion. As a result, the image data is converted into a data format printable by the printing unit. The print operation is executed based on the image data of this data format, forming an image.

Application software running on a PC according to a first embodiment of the present invention will be explained. As shown in FIG. 6, sheet music is scanned by an input device such as a scanner to convert each page into digital data (step S210). Then, each page is divided into grand staff blocks (step S220). Each grand staff block will be called a large block.

In FIG. 7, reference numeral 7A represents digital data (sheet music data) of sheet music scanned by an input device. Areas A to K indicated by broken lines in 7A of FIG. 7 are large blocks described above.

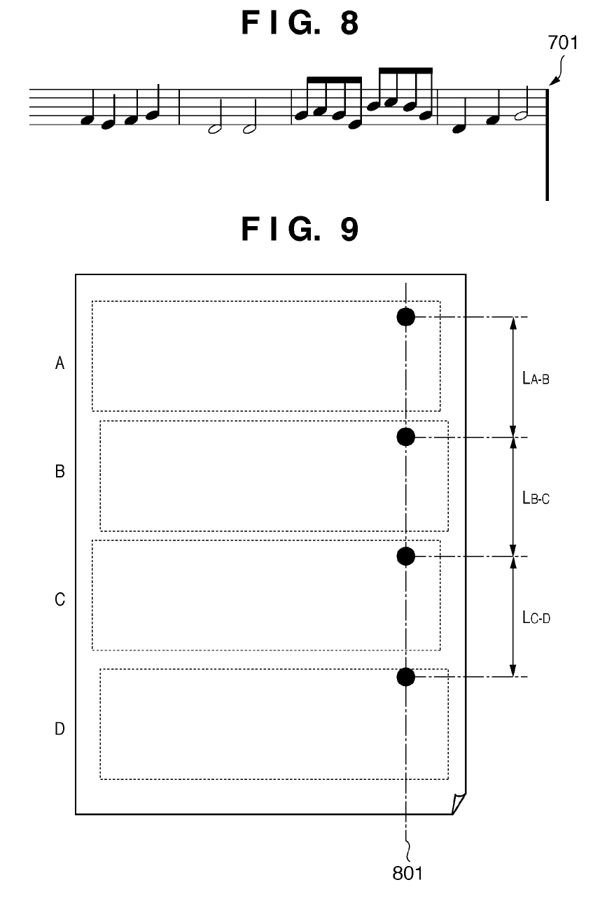

For example, the user trims these large blocks into rectangles with a mouse so that grand staffs of sheet music are fit in the rectangles. Information is managed for each trimmed rectangular area. The sizes of large blocks need not be strictly equalized. For example, the user sets reference coordinates for respective large blocks. That is, the user designates an upper right portion 701 in FIG. 8 as reference coordinates for each large block in actual sheet music. The reference coordinates are managed for respective large blocks as, for example, A(X,Y), B(X,Y), . . . . Note that 7A of FIG. 7 represents sheet music data of sheet music in which a sign 601 of large block F designates playing the hatched portions of large blocks B and C, and then playing bars up to large block K after the sign 601 of large block F.

Next, the user designates the divided large blocks in accordance with the order of performance using a display screen. The order of performance is managed as numbering data of the respective large blocks, and the large blocks are edited again based on the order of performance. In 7A and 7B of FIG. 7, large blocks are played in the order of A(1), B(2,7), C(3,8), D(4), E(5), F(6,9), G(10), H(11), I(12), J(13), and K(14). A numerical value in parentheses represents a number for managing a large block in accordance with the order of performance.

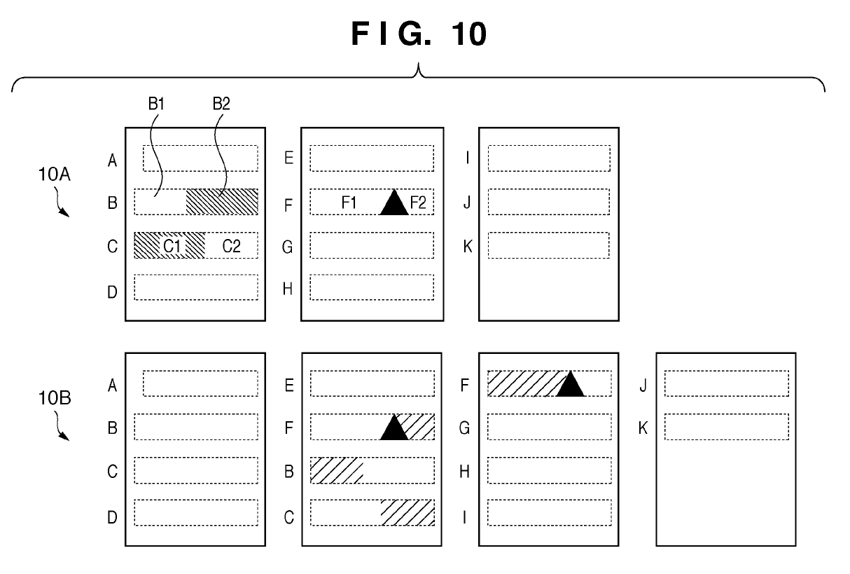

Finally, as represented by 7B of FIG. 7, the large blocks are edited again on the basis of the numbering data and the reference coordinates. Details of re-editing will be explained with reference to FIG. 9. The large blocks are aligned at the X-coordinate (horizontal coordinate in FIG. 9) of the reference coordinates on the basis of the reference coordinates of the large blocks that are managed for the respective large blocks. FIG. 9 shows a state in which the large blocks are aligned at a coordinate 801. The large blocks are edited again so that the Y-coordinates (vertical coordinates in FIG. 9) of the reference coordinates of the large blocks are set at equal intervals. That is, the respective blocks are edited again to meet L_{A-B}=L_{B-C}=L_{C-D}. As a result, laid-out sheet music data can be generated again. In this case, basically, the number of staffs arranged in a page need not be changed, but may also be changed if it improves readability.

According to the method of editing large blocks again on the basis of reference coordinates, large blocks trimmed by the user need not always be aligned obviously.

The first embodiment has described division into large blocks in accordance with user's manual designation. However, sheet music itself is mainly formed from lines, so it is also possible to analyze data of the background or the like and automatically extract large blocks and reference coordinates. Further, sheet music data for a performance may also be automatically generated by extracting signs from sheet music, recognizing them, analyzing the order of performance, and editing the sheet music again in accordance with the order of performance.

The first embodiment has described a method of dividing sheet music into large blocks, and editing the large blocks again in accordance with the order of performance to generate new sheet music. In a second embodiment, a large block is further divided into smaller middle blocks.

When dividing a large block into middle blocks, for example, the large block can be divided into bar blocks. However, no large block need always be divided into all bars. It suffices to divide, into middle blocks, only a large block including an area repetitively used during the performance.

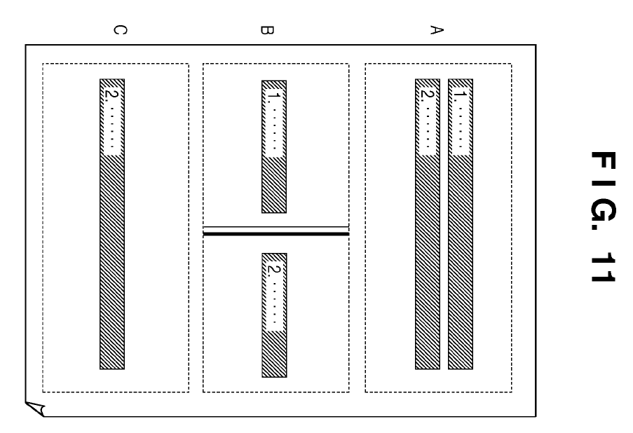

Assume that the hatched portions of large blocks B and C in 10A of FIG. 10 are also repetitively used in large block F, and the remaining bars of these blocks and large blocks other than blocks B and C are not repetitively used. In this case, large blocks B and C are divided into middle blocks B1, B2, C1, and C2 at boundaries each between a bar repetitively used and one not repetitively used. If there is a large block including a portion at which the performance pauses owing to a specific sign or the like, the large block is divided into middle blocks. In 10A of FIG. 10, large block F is divided into middle blocks F1 and F2 in advance.

After each large block is divided into middle blocks, as needed, the user designates the order of performance of respective large blocks. As represented by 10B of FIG. 10, large blocks are edited again in accordance with the order input by the user. At this time, as for a large block divided into middle blocks, the color of an area other than a designated middle block is changed. For example, for monochrome sheet music, the color is lightened, or changed into white to decolor the sheet music. That is, the color of an area not actually played in a large block is changed into a different color in re-edited sheet music. This can improve the readability of the sheet music in the performance.

As for coordinates designated by the user to divide a large block into middle blocks, the nearest line for separating bars may also be searched for to adjust an area to be changed in color. This makes it possible to more accurately color each bar.

The first embodiment has described a method of dividing sheet music into large blocks, and editing the sheet music again for each large block in accordance with the order of performance in order to easily turn a page of the sheet music during the performance by a player. The second embodiment has described a method of dividing some large blocks into middle blocks to improve the readability of sheet music. A third embodiment pays attention to sheet music with words. Even for sheet music with words, the layout of the sheet music as a book is not always convenient for a player, so the sheet music needs to be edited.

For example, in sheet music with words, the words of respective verses are generally arranged in line or side by side for the same melody (including a melody or a rhythm). There is an area used commonly for the words of respective verses, and there is also an area used for only the words of a specific verse. In many cases, the final phrase suddenly jumps to a distance.

From this, similar to the first embodiment, sheet music data obtained from an input device is divided into large blocks corresponding to grand staffs. Similar to the second embodiment, each large block may also be divided into middle blocks of bars in correspondence with an area used in the performance and an area not used.

The concept of the third embodiment will be explained in detail with reference to FIG. 11. In sheet music shown in FIG. 11, the words of the first and second verses are arranged in large block A. Only the words of the first verse are arranged in the right half of large block B, and only that of the second verse is arranged in the left half. Only the words of the second verse are arranged in large block C.

At this time, sheet music is divided into large blocks A to C, as described in the first embodiment. The reference coordinates of each large block are designated and managed as X- and Y-coordinates.

For a large block having bars, in each of which only the words of either verse are arranged, like block B, the large block is further divided into middle blocks, similar to the second embodiment. In this case, the user sequentially designates the word areas of large blocks with a mouse or the like. At this time, it is also possible to designate an area by trimming or line drawing, and automatically divide a large block into middle blocks on the basis of the position data.

Numbering data of large or middle blocks are managed in accordance with user designation, and the large blocks are edited again in accordance with the numbering data. This can set page feed directions in the performance to one direction, and the player can easily turn a page.

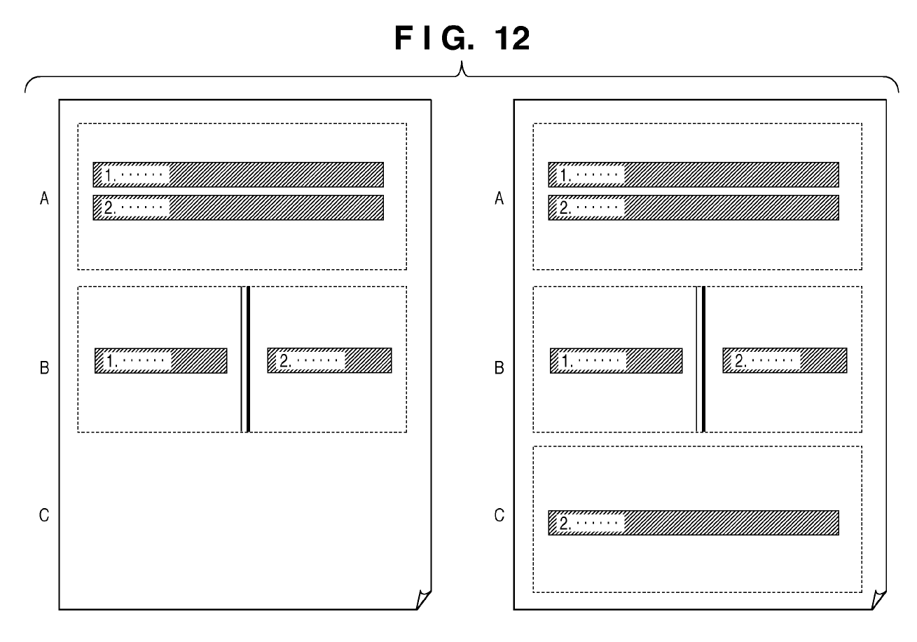

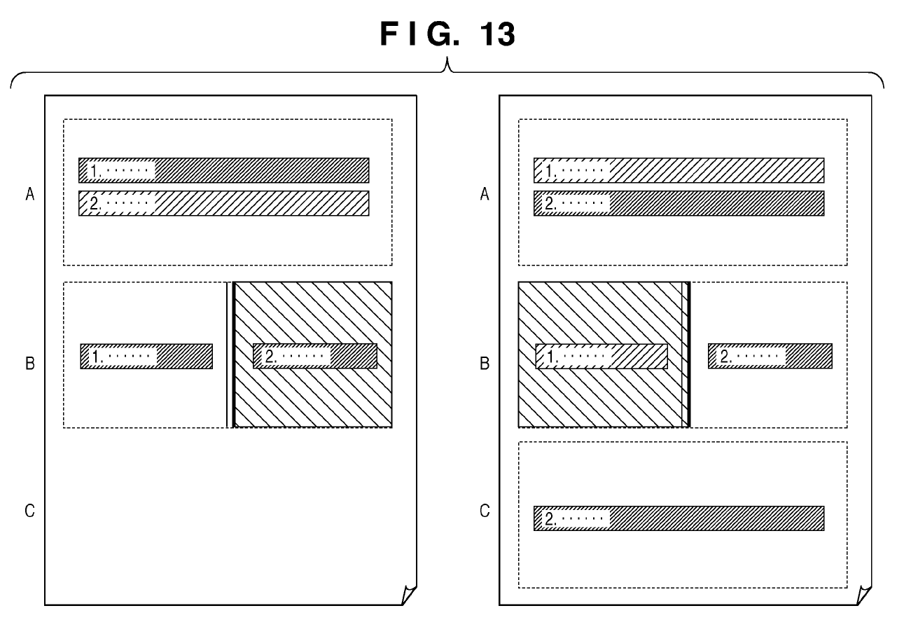

In sheet music with words, no margin need always be reduced in re-editing. A block at the beginning of words can be arranged at the beginning of a page, improving readability. At this time, sheet music data is edited again as shown in FIG. 12. The left side in FIG. 12 shows sheet music of the first page, and the right side shows that of the second page.

The third embodiment has described a method of managing numbering data and editing sheet music again on the basis of words-containing areas designated by the user. However, a words-containing area may also be divided in advance into small blocks. In a fourth embodiment, similar to the third embodiment, the user designates words-containing areas and the order of performance of the areas. When words other than those of designated small blocks belong to a single large block, the color of the words other than those of the designated small blocks is changed. Considering the attribute “words”, it can improve readability in the performance of sheet music to remove words other than those of designated small blocks as unnecessary words. For example, re-edited sheet music data in the fourth embodiment corresponding to sheet music data in FIG. 12 in the third embodiment is as shown in FIG. 13.

Words may also be recognized in advance as character information by OCR. Only part of the word area may also be divided into small blocks at once to manage data.

For descriptive convenience, the embodiments have exemplified sheet music with small numbers of staffs, repeat marks, and pages. However, the present invention is not limited by the numbers of staffs, repeat marks, and pages. Further, an embodiment for executing the sheet music creation method by application software in a PC has been explained. However, the present invention can also be practiced using an apparatus such as an MFP. The present invention can be practiced even using an apparatus such as an MFP having no liquid crystal monitor by describing information of the order of performance and the like on copied sheet music, desirably editing the sheet music on the basis of re-scanned data, and outputting the sheet music again.

The present invention is also practiced by supplying the program codes of software for implementing the functions of the above-described embodiments to, for example, an apparatus connected to various devices, and operating these devices in accordance with programs stored in the computer of the apparatus or the like.

In this case, the program codes of the software implement the functions of the above-described embodiments, and the program codes themselves and a means such as a computer-readable storage medium for supplying the program codes to a computer constitute the present invention. Concrete examples of the computer-readable storage medium are a flexible disk, hard disk, optical disk, magnetooptical disk, CD-ROM, magnetic tape, nonvolatile memory card, and ROM.

The present invention includes program codes when the functions of the above-described embodiments are implemented by executing the program codes supplied to the computer. The present invention also includes program codes when the functions of the above-described embodiments are implemented by an OS (Operating System) and another application software or the like running on the computer in cooperation with each other.

The functions of the above-described embodiments are also implemented when program codes supplied to the computer are stored in the memories of the function expansion board and function expansion unit of the computer, and, for example, the CPUs of the function expansion board and function expansion unit execute processing on the basis of the instructions of the program codes. The present invention also incorporates these program codes.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-331073, filed Dec. 21, 2007, which is hereby incorporated by reference herein in its entirety.

What is claimed is:

1. A sheet music creation method of creating sheet music whose layout is changed based on image data of sheet music input from an input device, the method comprising:
dividing the image data of the sheet music input from the input device into grand staffs;
designating the grand staffs divided in said dividing in order of performance; and
re-editing, by a processor, image data representing the grand staffs in accordance with the order designated in said designating.

2. The method according to claim 1, wherein
the input device includes a scanner, and
the image data includes image data of sheet music scanned by the scanner.

3. The method according to claim 1, wherein
said dividing comprises setting reference coordinates for predetermined portions of the divided grand staffs, and
said re-editing comprises setting positions of the grand staffs in the layout-changed sheet music on the basis of the reference coordinates.

4. The method according to claim 1, wherein said designating comprises designating the order of the grand staffs in accordance with a user instruction using a display screen.

5. The method according to claim 1, wherein when the sheet music input from the input device includes a repeat mark, said designating comprises designating the order of the grand staffs so as to arrange a grand staff including bars repeated by the repeat mark subsequently to a grand staff including the repeat mark, and subsequently arrange the grand staff including the repeat mark of the sheet music.

6. The method according to claim 5, further comprising outputting sheet music on the basis of the image data re-edited in said re-editing,
wherein said dividing comprises dividing the grand staff including the repeat mark of the sheet music into bars up to a bar including the repeat mark and bars subsequent to the repeat mark, and dividing the grand staff including the repeated bars into the bars repeated by the repeat mark and remaining bars, and
said outputting comprises outputting, in different colors, the bars subsequent to the bar including the repeat mark in the grand staff which is arranged before the grand staff including the repeated bars and includes the repeat mark of the sheet music, the remaining bars in the grand staff including the repeated bars, and the bars up to the bar including the repeat mark in the grand staff which includes the repeat mark of the sheet music and is subsequent to the grand staff including the repeated bars.

7. The method according to claim 1, wherein in said designating, the sheet music input from the input device includes sheet music with words.

8. A computer-readable storage medium storing a program configured to cause an image processing apparatus to execute the method of claim 1.

9. An image processing apparatus which is connected to an input device and creates sheet music whose layout is changed based on image data of sheet music input from the input device, the apparatus comprising:
a division unit configured to divide the image data of the sheet music input from the input device into grand staffs;
a designation unit configured to designate the grand staffs divided by said division unit in order of performance; and
a re-editing unit configured to re-edit, by a processor, image data representing the grand staffs in accordance with the order designated by said designation unit.

10. An image processing apparatus which includes an input device and creates sheet music whose layout is changed based on image data of sheet music input from the input device, the apparatus comprising:
a division unit configured to divide the image data of the sheet music input from the input device into grand staffs;
a designation unit configured to designate the grand staffs divided by said division unit in order of performance; and
a re-editing unit configured to re-edit, by a processor, image data representing the grand staffs in accordance with the order designated by said designation unit.
